(19) United States
(12) Patent Application Publication
(10) Pub. No.: US 2008/0141854 A1
(43) Pub. Date: Jun. 19, 2008

(54) Press having regeneration circuit

(75) Inventors: Douglas L. Friend, Albert Lea, MN (US); Jason Skarphol, Anoka, MN (US)

Correspondence Address: VIDAS, ARRETT & STEINKRAUS, P.A., SUITE 400, 6640 SHADY OAK ROAD, EDEN PRAIRIE, MN, 55344, US

(73) Assignee: Edwards MFG. CO., Albert Lea, MN (US)

(21) Appl. No.: 11/638,871

(22) Filed: Dec. 14, 2006

(51) Int. Cl. B30B 15/22

(52) U.S. Cl. 91/420; 91/418

(57) ABSTRACT

A hydraulic metalworking machine for working a work piece has a stand having a frame, a center portion which moves along a vertical path within the frame, and at least one hydraulic cylinder unit mounted in said stand. The machine has a high speed mode, a force mode, and a retract mode. During the high speed mode fluid flows into the power cylinder and extends the rod out at a high speed. During the force mode the rod extends out at a slower speed but under higher pressure than the high speed mode. During the retract mode fluid is moved into the cylinder rod end and fluid in the cylinder base end is removed.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

Hydraulic presses have been used for some time for working various metals. Due to the hardness and strength of iron, a great deal of pressure is required when working with iron pieces (e.g. mild steel plate, bar-stock, angle, rod, square stock, sheet metal, and pipe).

Working iron pieces can result in loud working conditions and expensive operation. An iron working machine that effectively works iron pieces while lowering costs and operating more quietly is desirable.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### SUMMARY OF THE INVENTION

The inventive iron working machine can apply hydraulic force to a moving center that moves within a frame in a simple, vertical path. It can exert force through shear blades, punch and die, notcher, brake dies, or bump-die tooling upon materials such as mild steel. Vertical travel of the moving center can allow the operator to perform multiple operations without removing any adjacent tooling.

In at least one embodiment, the invention is directed to a hydraulic metalworking machine for working a work piece. The machine includes a framework, a center portion supported by the framework and moveable about a longitudinal axis, and at least one hydraulic cylinder unit mounted in said framework and acting on the center portion. It should be noted here that each hydraulic cylinder need not contact the center portion nor directly act on the center portion. In at least some embodiments, the center portion moves vertically by action of the hydraulic cylinder unit. The hydraulic cylinder unit has a power cylinder and a rod slidably received in the power cylinder and extending from the power cylinder. In some embodiments the power cylinder has an end oriented towards the center portion and/or the rod extends to the center portion.

In some embodiments of the machine as embodied above, the power cylinder can have a cylinder rod end and a cylinder base end such that an opening in the cylinder base end allows fluid into the power cylinder which acts to extend the rod and an opening in the cylinder rod end allows fluid into the power cylinder which acts to retract the rod,

In at least one embodiment, the cylinder unit can be activated by a hydraulic circuit that can include the following components: a pump, a reservoir, a plurality of valves, a line to the cylinder base end, and a line to the cylinder rod end. In at least one embodiment, the components are in at least partial fluid communication with one another during the high speed mode, the force mode, and/or the retract mode. It should be noted that the term “at least partial fluid communication” includes full flow of fluid to very limited flow. In addition the term also includes flow when a valve or other device in the hydraulic system can be activated, deactivated, or removed in order to allow fluid flow into a region of the system originally without flow between components. In another sense the term includes a hydraulic system wherein different components are in at least partial fluid communication at different times during the functioning of the system such that all components are in communication with one another at some point.

In at least one embodiment, during the high speed mode the pump pumps fluid creating a first stream having a first pressure and a first flow volume that enters the power cylinder at the cylinder base end. Additionally, as the rod extends due to the entrance of the fluid into the cylinder base end, fluid from the cylinder rod end moves through a valve and combines with the fluid from the first stream to enter the power cylinder at the cylinder base end and extend the rod out at a faster rate than the first stream alone. In some embodiments, the high speed mode begins when a user initiates the process (e.g. presses a foot pedal) that initiates the pump to pump and direct fluid into the cylinder base end and ends when the center portion contacts a work piece. Contacting the work piece can cause pressure at the cylinder base end to build up and thereby initiate the force mode.

In at least one embodiment, during the force mode the first valve prevents fluid from directly flowing from the cylinder rod end to the cylinder base end while the fluid of the first stream continues to enter the cylinder base end. During the force mode the fluid of the first stream is moved at a second pressure greater than the first pressure and the rod extends out at a speed that is slower than the speed the rod extends out during the high speed mode.

In at least one embodiment, during the retract mode fluid is moved into the cylinder rod end and fluid in the cylinder base end is removed.

In at least one embodiment, a valve can be disposed between the pump and the cylinder unit; the valve has a first position and a second position wherein in the first position the valve directs fluid into the cylinder base end of the cylinder unit and in the second position the valve directs fluid into the cylinder rod end of the cylinder unit. A variety of valves can be used for this; a three way valve can be used to direct the flow from one port to another. In at least one embodiment, the valve is a directional control valve (e.g. a solenoid valve).

In at least one embodiment, during the high speed mode fluid from the cylinder rod end flows at a flow volume up to 5 times greater than the flow volume from the pump.

In at least one embodiment, a second valve can be disposed between the cylinder rod end and pump such that during the force mode the fluid exiting the cylinder rod end passes through the second valve which opens when the pressure of the fluid of the first stream reaches a set elevated pressure. In at least one embodiment, the second valve is a counterbalance valve. In at least one embodiment, this fluid is released into a reservoir upon passing through the second valve. The pump pumps fluid from the reservoir.

In at least one embodiment, during the retract mode a directional control valve is energized to direct fluid from the pump to the cylinder rod end and fluid from the cylinder base end is directed to a reservoir.

In at least one embodiment, during the retract mode the pump pumps all the fluid into the cylinder rod end that is used to extend the cylinder.

In at least one embodiment, the hydraulic metalworking machine has a punch station and a shear station which are disposed on different parts of the hydraulic metalworking machine.

In at least one embodiment, the cylinder base end of the cylinder unit is filled at substantially the same rate during the force mode as the cylinder rod end of the cylinder unit is filled during the retract mode.

In at least one embodiment, a measuring device measures the pressure at the cylinder base end and compares it to a preset value such that if the pressure is greater than the preset value the second valve opens. The second valve can act as a relief valve.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described an embodiments of the invention.

### BRIEF DESCRIPTION OF THE SEVERAL VIEWS OF THE DRAWING(S)

A detailed description of the invention is hereafter described with specific reference being made to the drawings.

FIG. 1 is a perspective view of the metal working machine.

FIG. 2 is a perspective view of the moveable center portion of a metal working machine.

FIG. 3 is a cut-away perspective view of a notching station of a metal working machine.

FIG. 4 is a cut-away perspective view of a braking station of a metal working machine.

FIG. 5 is a cut-away perspective view of a punching station of a metal working machine.

FIG. 6 is a cut-away perspective view of a notching station of a metal working machine.

FIG. 7 is a diagram of a hydraulic circuit that can be used in a metal working machine.

### DETAILED DESCRIPTION OF THE INVENTION

While this invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

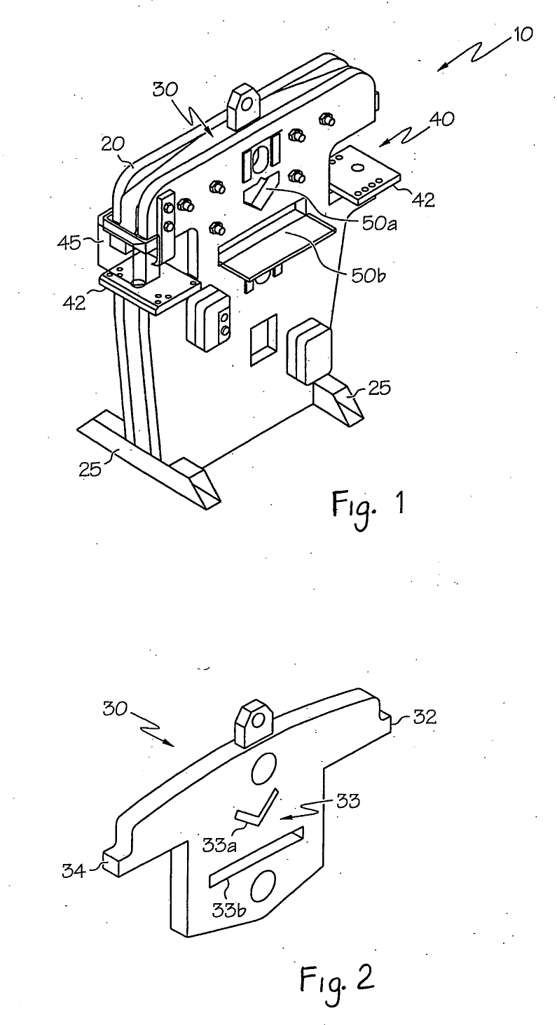

In FIG. 1 a metal working machine 10 is shown. It should be noted that the metal working machine need not be used solely with metal and can also be used in working a wide variety of materials including polymers, wood, and composites. The machine 10 as shown has a frame 20 with stabilizing legs 25. A moveable center portion 30 can move vertically within the frame 20. The moveable center portion 30 is acted upon by at least one hydraulic cylinder (not shown). The moveable center portion 30 can act on a first station 40, a second station 45, and a middle station 50/51. Thus, the moveable center portion 30 allows an operator to perform multiple operations at multiple stations (e.g. punch station, notch station, shear station, brake tooling station, gauging station) without having to remove adjacent tooling.

FIG. 2 illustrates moveable center portion 30 having first portion 32, middle portion 33, and second portion 34. The first portion 32 corresponds to the portion of the moveable center portion 30 used in the first station 40. Middle portion 33 comprises multiple shearing capabilities for shearing solid rods, squares, angle and bar stock. As illustrated in FIG. 2 an angled aperture 33a and a slot aperture 33b are shown and correspond to middle station 50a/50b of FIG. 1. Second portion 34 correspond to the portion of the moveable center portion 30 used in the second station 45. It should be noted that while the metal working machine of FIG. 1 has multiple stations, some embodiments of the invention provide only a single station. Middle work station portion 50a can be used for shearing solid rods, squares, angle and bar stock, but particularly can be used for shearing angle iron (e.g. angle iron having the dimensions 2″×2″×¼″). The middle work station portion 50b can be used for shearing a variety of rods, squares, and bar stock (e.g. bar stock having the dimensions ¼″×6″).

FIG. 3 illustrates a coper notcher 60 (also known as a nibbler) within the first or second station 40/45. Attached to the mounting table 42 is the notcher base block 61 having a slot 62. Attached to the moveable center 30 is a notching head 63 that can be pressed into slot 62. A workpiece (e.g. plate, barstock or angle) placed into the space 64 between the notcher head 63 and the block base 61 is notched by downward vertical movement of the notcher head 63 into the slot 62.

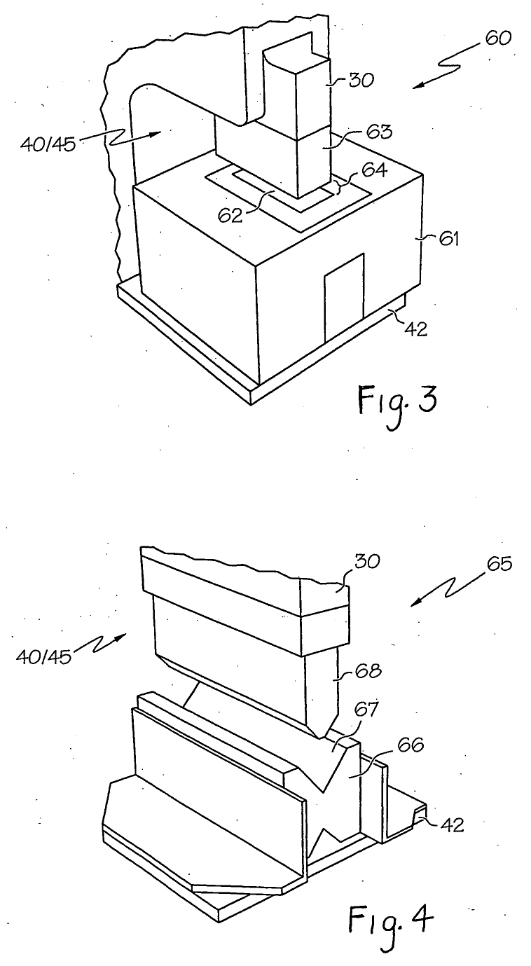

FIG. 4 illustrates brake tooling 65 within the first or second station 40/45. Attached to the mounting table 42 is the bottom brake die 66 having an angled slot 67. Attached to the moveable center 30 is a braking head 68 that can be pressed into angled slot 67. A workpiece placed into the space between the braking head 68 and the bottom brake die 66 is broke (i.e. bent) to a substantially 90 degree angle by downward vertical movement of the braking head 68 into the angled slot slot 67. The angled slot 67 can also have a more acute or obtuse angle than 90 degrees.

Brackets, frames, pans and tanks are just a few of the applications appropriate for brake tooling. The brake tooling head 68 and bottom brake die 66 can be a variety of lengths including 7-12″ lengths and can be effective on 1/16-¼″ iron base material. The bottom brake die can be held with brackets that bolt to the mounting table 42.

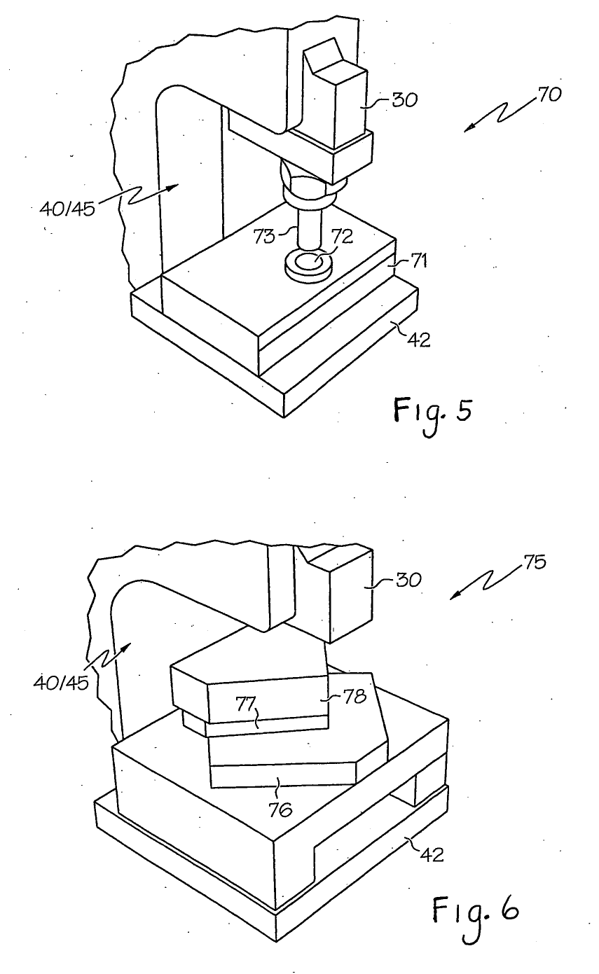

FIG. 5 illustrates a punch tooling 70 within the first or second station 40/45. Attached to the mounting table 42 is the bottom block die 71 has a circular hole or slot 72. Attached to the moveable center 30 is a punching head 73 that can be pressed into circular hole 72. A workpiece placed into the space between the punching head 73 and the bottom block die 71 can have a hole punched therethrough by downward vertical movement of the punching head 73 into the circular hole 72. The punch tooling can be sized to punch holes of a variety of custom shapes and sizes (e.g., up to 1 9/16″ round or larger in 1/32″ increments).

FIG. 6 illustrates Vee-Notcher tooling 75 within the first or second station 40/45. Attached to the mounting table 42 is the bottom Vee-notch die 76 having an angled slot 77. Attached to the moveable center 30 is a notching head 78 that can be pressed into angled slot 77. A workpiece placed into the space between the notching head 78 and the Vee notch die 76 is notched to a precise 92 degree notch, though other notch angles can be cut with other Vee-notch dies. When applied to the angle iron frame industry, the Vee-Notcher tooling can take a precise 92 degree notch from the bottom leg of angle up to 3″×3″×¼″ profiles. Once cut, the uncut top leg profile is placed in brake tooling for a precise 90 degree bend to create an angle iron frame. This tooling is widely used in fabrication shops that create sub-frame assemblies for other industries

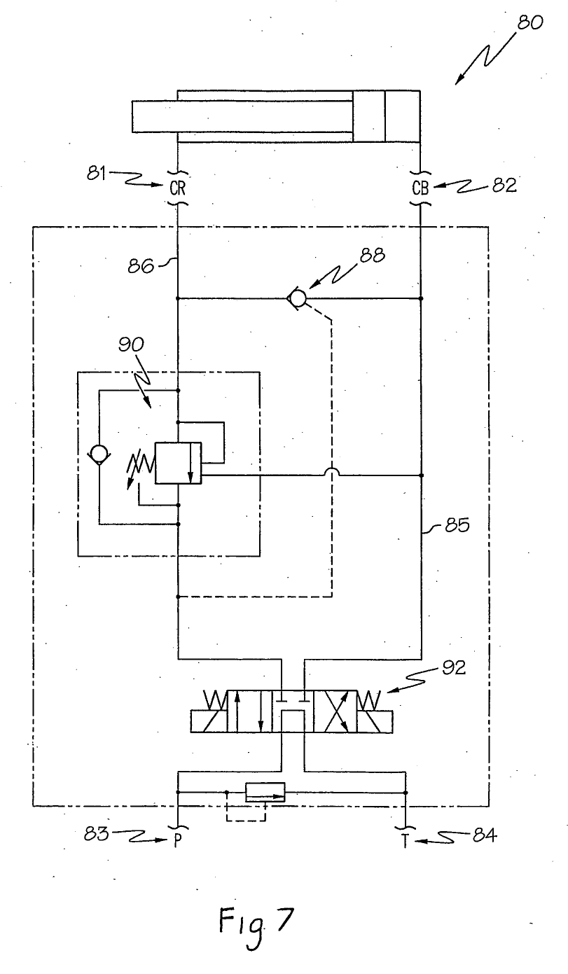

FIG. 7 illustrates a hydraulic circuit that can be used in a metal working machine 10. The metal working machine has a hydraulic cylinder unit that has a power cylinder and a rod slidably received in the power cylinder and extending from the power cylinder. The power cylinder has a cylinder rod end 81 and a cylinder base end 82 such that an opening in the cylinder base end allows fluid into the power cylinder which acts to extend the rod and an opening in the cylinder rod end allows fluid into the power cylinder which acts to retract the rod. The circuit has a high speed mode that occurs when fluid from the pump and fluid from the cylinder rod end are combined and enter the cylinder base end which can result in faster extension of the rod within the cylinder. The cylinder also has a power mode that can be initiated by the rod contacting a workpiece which can result in a pressure build-up at the cylinder base end. When this occurs fluid from the cylinder rod end flows to a tank or reservoir and does not combine with the fluid from the pump that is directed into the cylinder base end. In the force mode the rod extends more slowly and under greater pressure than when in the high speed mode. In the retract mode fluid is directed into the cylinder rod end and fluid from the cylinder base end is directed to the reservoir. The pump can draw fluid from the reservoir during all of these modes.

The hydraulic circuit described above can be constructed in multiple ways. One such way is illustrated in FIG. 7. The cylinder unit can be activated by the hydraulic circuit 80 illustrated in FIG. 7. The hydraulic circuit has components which include a pump 83, a reservoir tank 84, a plurality of valves, a line to the cylinder base end 82, and a line to the cylinder rod end 81. In at least one embodiment, the components are in at least partial fluid communication with one another during the high speed mode, the force mode, and/or the retract mode.

During the high speed mode the pump 83 pumps fluid through the first stream line 85 having a first pressure and a first flow volume that enters the power cylinder at the cylinder base end 82. Additionally, as the rod extends due to the entrance of the fluid into the cylinder base end, fluid from the cylinder rod end 81 moves through a first valve 88 and combines with the fluid from the first stream line 85 to enter the power cylinder at the cylinder base end 82 thereby extending the rod out at a faster rate than the first stream line 85 produced by the pump 83 alone. In some embodiments, the high speed mode begins when a user initiates the process (e.g. presses a foot pedal) that activates the pump 83 to pump and direct fluid into the cylinder base end 82 and ends when tooling attached to the center portion 30 contacts a work piece. Contacting the work piece can cause pressure at the cylinder base end 82 and line 85 to build up and thereby initiate the force mode.

During the force mode the pressure measured at the cylinder base end 82 is greater than a preset pressure in the second valve 90 thereby opening the second valve 90 (e.g. a counterbalance valve) such that the fluid from the cylinder rod end is directed into the reservoir tank 84. The build-up of pressure in line 85 and at the cylinder base end also causes first valve 88 to close which prevents fluid from directly flowing from the cylinder rod end 81 to the cylinder base end 82 while the fluid of the first stream line 85 from the pump continues to enter the cylinder base end. During the force mode the fluid of the first stream line 85 is moved at a second pressure greater than the first pressure and the rod extends out at a speed that is slower than the speed the rod extends out during the high speed mode.

During the retract mode the third valve 92 directs fluid to the cylinder rod end 81 and fluid in the cylinder base end 82 is directed to the reservoir tank 84. Thus, the rod retracts within the cylinder. As fluid is directed to the cylinder rod end 81, pressure in line 95 increases thereby holding valve 88 closed to prevent fluid directed to the cylinder rod end 81 from entering the cylinder base end 82. In some embodiments the third valve is a directional control valve such as a solenoid valve.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims may be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the invention. Those skilled in the art may recognize other equivalents to the specific embodiment described herein which equivalents are intended to be encompassed by the claims attached hereto.

What is claimed is:

1. A hydraulic metalworking machine for working a work piece comprising:
(a) a framework;
(b) a center portion supported by the framework and moveable about a longitudinal axis, the center portion applying pressure to the work piece;
(c) at least one hydraulic cylinder unit mounted in said framework; the at least one cylinder unit acting on the center portion and having:
a power cylinder having an end oriented towards the center portion; and
a rod slidably received in the power cylinder and extending from the power cylinder to said center portion;
the power cylinder having a cylinder rod end and a cylinder base end, an opening in the cylinder base end allows fluid into the power cylinder which acts to extend the rod, an opening in the cylinder rod end allows fluid into the power cylinder which acts to retract the rod,
the at least one hydraulic cylinder unit having a high speed mode, a force mode, and a retract mode, during the high speed mode fluid from a first stream is moved at a first pressure and a first flow volume into the power cylinder at the cylinder base end and fluid from the cylinder rod end moves through a first valve and combines with the fluid from the first stream to enter the power cylinder at the cylinder base end, the rod extends out at a first speed;
during the force mode the first valve prevents fluid from directly flowing from the cylinder rod end to the cylinder base end while the fluid of the first stream continues to enter the cylinder base end, during the force mode the fluid of the first stream is moved at a second pressure greater than the first pressure and the rod extends out at a second speed, the second speed slower than the first speed;
during the retract mode fluid is moved into the cylinder rod end and fluid in the cylinder base end is removed.

2. The hydraulic metalworking machine of claim 1 wherein the fluid of the first stream is moved by a pump and directed toward the cylinder base end of the cylinder unit.

3. The hydraulic metalworking machine of claim 2 wherein a directional control valve between the pump and the cylinder unit has a first position and a second position, in the first position the directional control valve directs fluid into the cylinder base end of the cylinder unit, in the second position the directional control valve directs fluid into the cylinder rod end of the cylinder unit.

4. The hydraulic metalworking machine of claim 3 wherein during the high speed mode fluid from the cylinder rod end flows at a second flow volume, the second flow volume being up to 5 times greater than the first flow volume.

5. The hydraulic metalworking machine of claim 4 wherein the force mode is initiated as the center portion contacts the workpiece within the machine.

6. The hydraulic metalworking machine of claim 4 wherein during the force mode the fluid exiting the cylinder rod end passes through a second valve, the second valve opening when the pressure of the fluid of the first stream reaches a set elevated pressure.

7. The hydraulic metalworking machine of claim 6 wherein the fluid exiting the cylinder rod end and passing through the second valve is released into a reservoir, the pump pumping fluid from the reservoir.

8. The hydraulic metalworking machine of claim 3 wherein during the retract mode the directional control valve is activated to direct fluid from the pump to the cylinder rod end and fluid from the cylinder base end is directed to a reservoir.

9. The hydraulic metalworking machine of claim 8 wherein during the retract mode the pump pumps all the fluid into the cylinder rod end that is used to extend the cylinder.

10. The hydraulic metalworking machine of claim 1 having a punch station and a shear station, the punch station and the shear station disposed on different parts of the hydraulic metalworking machine.

11. The hydraulic metalworking machine of claim 6 wherein the second valve is a counterbalance valve.

12. The hydraulic metalworking machine of claim 1 wherein the cylinder base end of the cylinder unit is filled at substantially the same rate during the force mode as the cylinder rod end of the cylinder unit is filled during the retract mode.

13. The hydraulic metalworking machine of claim 6 wherein a measuring device measures the pressure at the cylinder base end and compares it to a preset value such that if the pressure is greater than the preset value the second valve opens.

14. A hydraulic metalworking machine for working a work piece comprising:
(a) a framework;
(b) a center portion supported by the framework and moveable about a longitudinal axis, the center portion applying pressure to the work piece;
(c) at least one hydraulic cylinder unit mounted in said framework; each cylinder unit acting on the center portion and having:
a power cylinder; and
a rod slidably received in the power cylinder and extending from the power cylinder to said center portion;
the power cylinder having a cylinder rod end and a cylinder base end, an opening in the cylinder base end allows fluid into the power cylinder which acts to extend the rod, an opening in the cylinder rod end allows fluid into the power cylinder which acts to retract the rod,
the cylinder unit being activated by a hydraulic circuit, the hydraulic circuit having components including a pump, a reservoir, a first valve, a second valve, a third valve, a line to the cylinder base end, and a line to the cylinder rod end, the components in at least partial fluid communication with one another in at least one of the circuit modes which include a high speed mode, a force mode, and a retract mode,
during the high speed mode the pump pumps fluid creating a first stream having a first pressure and a first flow volume, the first stream entering the power cylinder at the cylinder base end, as the rod extends fluid from the cylinder rod end moves through a first valve and combines with the fluid from the first stream to enter the power cylinder at the cylinder base end and extend the rod out at a faster rate than the first stream alone;
during the force mode the first valve prevents fluid from directly flowing from the cylinder rod end to the cylinder base end while the fluid of the first stream continues to enter the cylinder base end, during the force mode the fluid of the first stream is moved at a second pressure greater than the first pressure and the rod extends out at a second speed, the second speed slower than the first speed;
during the retract mode fluid is moved into the cylinder rod end and fluid in the cylinder base end is removed.

15. The hydraulic metalworking machine of claim 14 wherein the third valve is a directional control valve disposed between the pump and the cylinder unit and has a first position and a second position, in the first position the directional control valve directs fluid into the cylinder base end of the cylinder unit, in the second position the directional control valve directs fluid into the cylinder rod end of the cylinder unit.

16. The hydraulic metalworking machine of claim 14 wherein during the high speed mode fluid from the cylinder rod end flows at a second flow volume, the second flow volume being up to 5 times greater than the first flow volume.

17. The hydraulic metalworking machine of claim 14 wherein the force mode is initiated as the center portion contacts the workpiece within the machine.

18. The hydraulic metalworking machine of claim 14 wherein during the force mode the fluid exiting the cylinder rod end passes through the second valve, the second valve opening when the pressure at the cylinder base end reaches a set elevated pressure.

19. The hydraulic metalworking machine of claim 14 wherein during the retract mode the third valve is a directional control valve activated to direct fluid from the pump which pumps all the fluid into the cylinder rod end that is used to extend the cylinder and fluid from the cylinder base end is directed to a reservoir.

20. The hydraulic metalworking machine of claim 14 having a punch station and a shear station, the punch station and the shear station disposed on different parts of the hydraulic metalworking machine.
